(19) United States
(12) Patent Application Publication
(10) Pub. No.: US 2023/0192060 A1
(43) Pub. Date: Jun. 22, 2023

(54) METHOD FOR CHECKING THE AVAILABILITY OF A HYDRAULIC FALLBACK LEVEL IN A POWER BRAKE SYSTEM WITH ELECTRONIC SLIP CONTROL; ELECTRONIC CONTROL DEVICE FOR A POWER BRAKE SYSTEM WITH ELECTRONIC SLIP CONTROL, AND POWER BRAKE SYSTEM WITH ELECTRONIC SLIP CONTROL HAVING AN ELECTRONIC CONTROL DEVICE

(71) Applicant: Robert Bosch GmbH, Stuttgart (DE)

(72) Inventors: Nikolas Loeffelmann, Heilbronn (DE); Florian Haag, Ellhofen (DE); Martin Marquart, Reichenbach (DE)

(21) Appl. No.: 17/996,061

(22) PCT Filed: Jun. 15, 2021
(86) PCT No.: PCT/EP2021/066006

§ 371 Date: Oct. 12, 2022

(30) Foreign Application Priority Data
Aug. 20, 2020 (DE) 10 2020 210 598.7

(51) Int. Cl. B60T 17/22; B60T 13/14; B60T 13/66; B60T 13/74; B60T 7/04; B60T 8/1761; B60T 8/40

(52) U.S. Cl. CPC B60T 17/22; B60T 13/146; B60T 13/662; B60T 13/745; B60T 7/042; B60T 8/17616; B60T 8/4013; B60T 2270/402; B60T 2270/406; B60T 2270/413

(57) ABSTRACT

A method for checking the availability of a hydraulic fallback level in a power brake system with electronic slip control, an electronic control device, and a power brake system with electronic slip control. In normal operation, power brake systems perform braking procedures without a driver participating in building up braking pressure. A requirement for braking is detected by an electronic control device and associated with a braking pressure which is set by electrical control of the drive of a primary pressure generator. Power brake systems are often equipped with a secondary pressure generator, connected with the wheel brakes, in parallel with the primary pressure generator, which can be used to perform the building up of pressure at a hydraulic fallback level. For safety reasons, the availability of the hydraulic fallback level is checked at particular time intervals during normal braking operation of the power brake system.

### FIELD

The present invention relates to a method for checking the availability of a hydraulic fallback level in a power brake system with electronic slip control. Moreover, the present invention relates to an electronic control device for a power brake system with electronic slip control, and to a power brake system with electronic slip control having an electronic control device.

### BACKGROUND INFORMATION

The present invention takes as its starting point a power brake system with electronic slip control that is known from the prior art. By way of example, reference is made in this regard to the German Patent Application No. DE 10 2018 222 488 A1.

This conventional power brake system comprises a service brake that is actuated by external power, and an auxiliary brake that can be actuated by muscle power. Under normal conditions, the service brake can perform a braking procedure without the driver participating in building up braking pressure. For this purpose, a requirement for braking is identified or made by the driver or a vehicle sensor system, and communicated to an electronic control device. This control device calculates the required braking pressure and accordingly controls a drive of a pressure generator. The auxiliary brake is provided in order, in the event of a defect in the service brake, to brake the vehicle by muscle power of the driver.

The conventional power brake system is organized into a plurality of assemblies. These are, for example, constructed separated from one another and brought into contact with one another hydraulically. Among the reasons for this are the constricted space conditions in a vehicle, and the possibility provided by this divided construction of arranging the assemblies at different locations. A first assembly is provided in order to detect a braking request made by the driver. For this purpose, it is equipped with the above-mentioned brake actuation element and with a primary or first pressure generator, for building up the required braking pressure. The primary pressure generator includes an electrically controllable drive, which is controlled by the electronic control device.

Under normal conditions, the second assembly serves to adjust this set braking pressure to the slip conditions currently prevailing at the wheels of a vehicle which are associated with the wheel brakes, the adjustment being made at each wheel individually. For this purpose, this second assembly is equipped with a secondary or second pressure generator drivable in electrically controlled fashion and also with a valve device that can likewise be controlled electrically. This valve device comprises a plurality of reversible multiway valves.

The two assemblies are brought into contact with the wheel brakes of a motor vehicle hydraulically and in parallel with one another.

The conventional power brake system is to be operated in various operating modes. In a first operating mode (normal operation), as mentioned above the braking pressure is provided by the primary or first braking pressure generator, and where necessary is adjusted by the secondary or second pressure generator, at each wheel individually.

In a second operating mode (hydraulic fallback level) of the power brake system, there is a fault in pressure generation by the first assembly, and the still functional secondary pressure generator is used to apply braking pressure to the wheel brakes. Accordingly, the second assembly is provided in addition to the above-mentioned braking pressure adjustment made at each wheel individually, in order to safeguard the power brake system against possible faults in the first assembly. Because of the provided redundancy in pressure generation, the power brake system is suitable for use in motor vehicles that can be driven autonomously or by a driver.

Because, under normal conditions, the second assembly is activated only seldom, there is a risk that possible functional faults in this second assembly are not identified promptly and so the hydraulic fallback level might not be available when needed.

### SUMMARY

In order to identify faults in the second assembly promptly and where appropriate to alert a driver, the present invention provides checking the availability of the hydraulic fallback level and hence the proper functioning of the second assembly, with its secondary or second pressure generator, at regular intervals during normal operation of the power brake system, for safety reasons. The time intervals between the individual checking cycles can be determined however desired, and may vary for example depending on the amount of use made of the power brake system.

The provided method according to the present invention is carried out without driver participation—that is to say decoupled from the driver—and ensures that a vehicle can still be safely braked to a standstill in the event that proper functioning of the first assembly, in particular the primary pressure generator, is faulty. Here, it is immaterial whether the fault that is present is attributable to mechanical causes, for example at the pressure generator, to electrical causes, for example at the drive of this pressure generator, and/or to electronic causes in the control of the drive.

Advantageous developments of the checking method according the present invention are disclosed herein.

For example, according to an example embodiment of the present invention, when a braking request is made in normal operation, the drive of the primary pressure generator be suppressed by the electronic control device and that in its stead the drive of the secondary pressure generator be controlled electrically. In other words, in select braking procedures, the braking pressure is generated not by the primary pressure generator, in the default manner, but by the secondary pressure generator, in order in this way to test that it is functional.

If the braking pressure is built up by the secondary pressure generator in the manner expected—that is to say if the braking pressure builds up in the manner expected—and the desired braking pressure is reached within an expected timeframe from the start of electrical control of the secondary pressure generator, then it can be assumed that the hydraulic fallback level is in the proper condition. A braking procedure that follows the braking procedure can then be carried out again using the primary pressure generator, in the default manner.

Additionally, the method according to another example embodiment of the present invention provides that the secondary brake pressure generator be controlled electrically when there is no braking request and that, at the latest at the same time as this electrical control of the secondary pressure generator, a hydraulic connection between this secondary braking pressure generator and the wheel brakes with which it is in contact be broken. The valve device of the second assembly may preferably be used for this.

In this method, there is thus no build-up of braking pressure in the wheel brakes and hence no braking of the vehicle. Only the regions of the power brake system that—from a hydraulic point of view—are located between the secondary pressure generator and the wheel brakes have braking pressure applied to them.

The pressure build-up in these regions may be detected and evaluated for example by way of sensors that are present in any case, for adjusting the braking pressure of the power brake system. Provided no braking event is requested, the method according to the example embodiment of the present invention may likewise be carried out during regular driving of a vehicle.

In the method according to an example embodiment of the present invention, it is particularly advantageous that, because of the noise of driving and ambient noise that are present, the occupants of the vehicle are not disturbed by noise that is produced by starting up the secondary pressure generator, and ideally the occupants of the vehicle do not notice the checking method going on.

According to an example embodiment of the present invention, the method is carried out once the vehicle has come to a standstill. In this case, braking pressure is also applied to the wheel brakes. In this case too, the course of the build-up of braking pressure can be monitored and assessed, albeit without needing to break the connections between the secondary pressure generator and the wheel brakes. This method is accordingly distinguished in that only a small number of the electrically controllable actuators of a power brake system have to be actuated, and hence little electrical power is required to carry out this method.

The vehicle is at a standstill after a stopping procedure in regular driving, or once it is parked. Thus, this example method does not necessarily require a vehicle drive to be active or a driver to be present.

According to an example embodiment of the present invention, as a possible criterion for assessing availability of the hydraulic fallback level, comparing the braking pressure generated by the secondary pressure generator (actual braking pressure) with a limit value for this braking pressure which is stored in the electronic control device (setpoint braking pressure). There is availability of the hydraulic fallback level if the generated braking pressure is equal to or greater than this limit value. As mentioned above, pressure may be detected with the aid of the sensor system for adjusting the braking pressure, which is present in any case in a power brake system, so no additional expense for parts arises.

As an alternative, according to an example embodiment of the present invention, instead of the generated pressure, the power consumption of the drive be evaluated during the generation of braking pressure by the secondary pressure generator, since this power consumption is proportional to the pressure built up. Power consumption of the drive of the secondary pressure generator can be detected by measuring the current flowing to the drive from the electronic control device of the power brake system.

Further advantageous or advantageous developments of the present invention will emerge from the description of the present invention below.

### BRIEF DESCRIPTION OF THE DRAWINGS

The present invention is explained in detail in the description below, with reference to the figures.

FIGS. 1A and 1B show the hydraulic layout of a power brake system providing the basis for the present invention.

FIG. 2 shows a flow chart of a first variant embodiment of the present invention.

FIG. 3 shows a flow chart of a second variant embodiment of the present invention.

FIG. 4 shows a flow chart of a third variant embodiment of the present invention.

### DETAILED DESCRIPTION OF EXAMPLE EMBODIMENTS

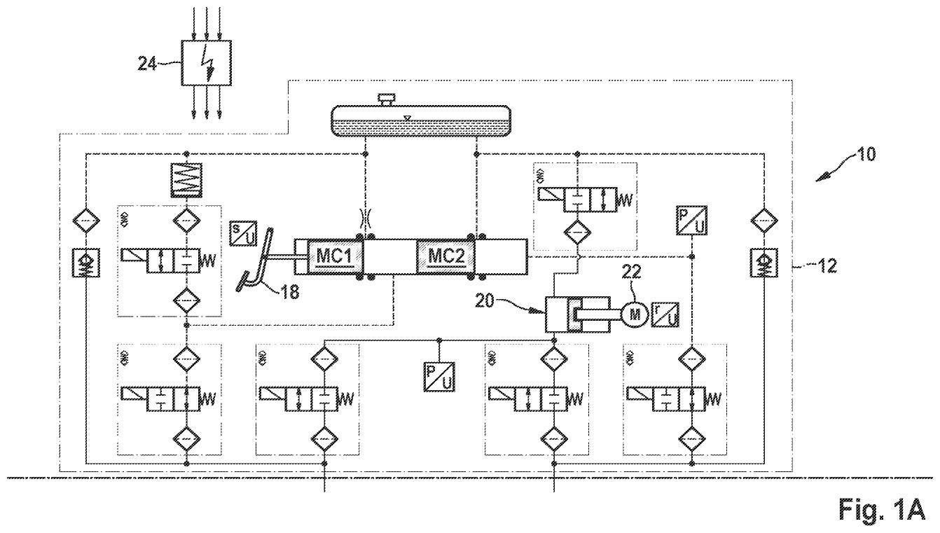

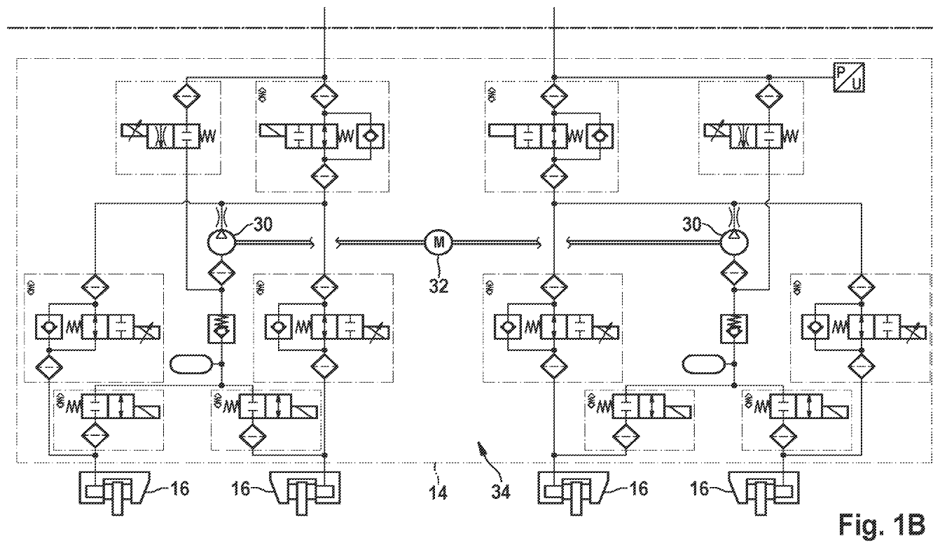

FIGS. 1A and 1B show, with the aid of hydraulic circuit symbols and their hydraulic connections with one another, the basic layout and organization of a power brake system providing the basis for the present invention. For details of this power brake system, reference is made to the description in German Patent Application No. DE 10 2018 222 488 A1; the description below goes again into certain points for an understanding of the present invention.

As mentioned above, the power brake system (10) providing the basis for the present invention is organized into two assemblies (12; 14), which, for example, are constructed separated from one another and brought into in hydraulic contact with one another. The two assemblies (12; 14) are connected hydraulically and in parallel with one another, and supply, for example, four wheel brakes (16) of power supply brake (10) with pressurized medium under braking pressure. In each case, two of these four wheel brakes are grouped together in one of a total of two brake circuits of power brake system (10).

First assembly (12) comprises, among other things, an actuation element (18) by way of which a brake request can be specified by the driver of a motor vehicle. Actuation element (18) is illustrated as a pedal, but could also be a manual lever. Moreover, first assembly (12) comprises a primary pressure generator (20) which can be actuated by an electrically controllable drive (22). The electric control is determined by an electronic control device (24), which ascertains control signals that correspond to the brake request and passes them on to drive (22) of primary pressure generator (20). Driven pressure generator (20) then supplies wheel brakes (16) of power brake system (10) with pressurized medium at a uniform braking pressure.

Connected hydraulically and in parallel with first assembly (12), and in contact with wheel brakes (16), is second assembly (14), which is equipped with a second or secondary pressure generator (30). In addition to secondary pressure generator (30) and its drive (32), second assembly (14) comprises a valve device (34) made up of a plurality of multiway valves for controlling power brake system (10). Like drive (32) of secondary pressure generator (30), these multiway valves can be controlled electrically. It is the task of second assembly (14) to adjust the braking pressure at each wheel individually and at the same time to adapt it to the slip conditions currently prevailing at the wheels associated with wheel brakes (16). If needed, a corresponding electrical control of drive (32) of secondary pressure generator (30), and where appropriate of the multiway valves of valve device (34), is likewise determined and performed by electronic control device (24).

The power brake system (10) constructed in this manner can be operated in normal operation, as described above, or at a hydraulic fallback level. In the case of the hydraulic fallback level, there is a fault in pressure generation in first assembly (12), and the build-up of braking pressure is performed by an electrical control of secondary pressure generator (30) of second assembly (14). At the same time, an alert is output to the driver to have power brake system (10) repaired.

Second assembly (14) accordingly safeguards functionality of power brake system (10) at the hydraulic fallback level, and for this reason should be checked for functionality from time to time, for safety reasons. Methods to this purpose are illustrated in the figures below.

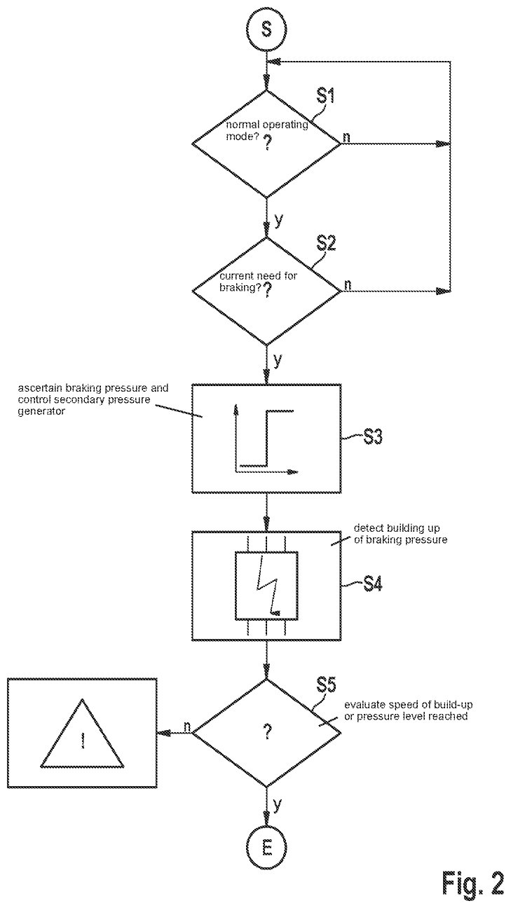

A first method, on which the present invention is based, for checking the availability of a hydraulic fallback level in a power brake system (10) with electronic slip control is shown in FIG. 2. This method requires power brake system (10) to be operating in normal mode, so the first method step S1 of this checking method consists in a query to this effect.

If the query result is positive, a query is made in step S2 as to whether there is a current need for braking or a braking request. If this is the case, electronic control device (24) ascertains a braking pressure that corresponds to the braking request and outputs a corresponding control signal for controlling secondary pressure generator (30) and its drive (32) (step S3). At the same time, an electrical control of drive (22) of primary pressure generator (20), which generates the braking pressure in normal operation, is suppressed.

In step S4, which now follows, the build-up of braking pressure in power brake system (10) that takes place is detected by electronic control device (24). There, a logic system provided for this purpose evaluates, for example, the speed of pressure build-up and/or the pressure level reached within a timeframe. If a comparison (step S5) with the setpoint values stored in control device (24) gives the result that the build-up of braking pressure has occurred in the manner expected, the conclusion is drawn that the hydraulic fallback level is available, and the method ends. If by contrast the build-up of braking pressure does not correspond to expectations, the conclusion is drawn that there is a fault in the hydraulic fallback level, and an alert such as an acoustic and/or visual signal is output to the driver.

If the queries in either of steps S1 or S2 give a negative result, the method is aborted, and is executed again from the beginning after a determinable time interval has elapsed.

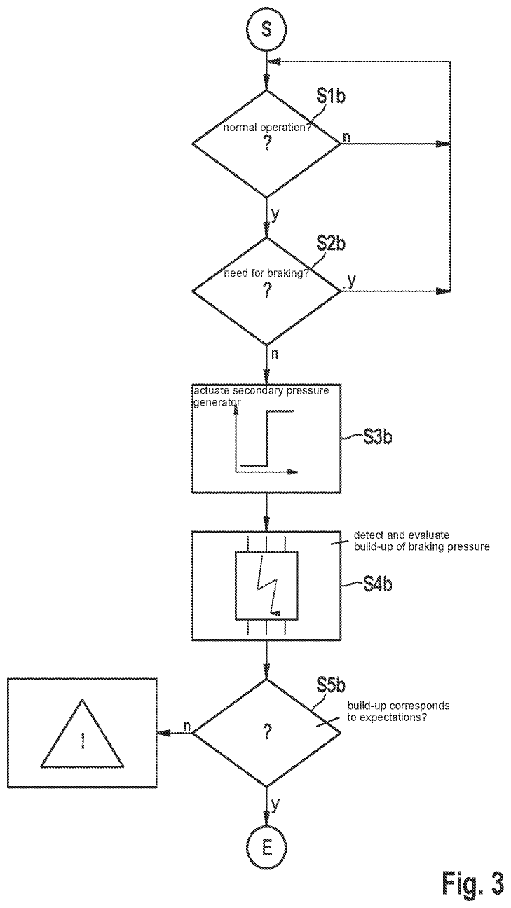

FIG. 3 illustrates a second, alternative method.

First of all, in this method, step S1b is carried out and a query made regarding normal operation.

If normal operation applies, in the following step S2b there is a query as to whether there is a need for braking, and—unlike the method according to FIG. 2—the method is only continued if there is no braking request. In step S3b, secondary pressure generator (30) of power brake system (10) is actuated, and at the same time as the beginning of this actuation the pressurized medium connections to wheel brakes (16) are broken. For this, advantageously the valves of valve device (34) of second assembly (14) may accordingly be controlled electrically. Consequently, braking pressure is applied only to a region of power brake system (10) located between secondary pressure generator (30) and wheel brakes (16), but not to wheel brakes (16) themselves. Thus, braking of the vehicle does not take place.

In step S4b, the build-up of braking pressure is once again detected and evaluated by electronic control device (24). If a comparison with the setpoint values stored in control device (24) gives the result that the build-up of braking pressure corresponds to expectations, then in S5b the conclusion is drawn that the hydraulic fallback level is available, and the method ends. If by contrast the build-up of braking pressure does not correspond to expectations, the conclusion is drawn that there is a fault in the hydraulic fallback level, and an alert such as an acoustic and/or visual signal is output to the driver.

If the query in step S1b gives a negative result, or if the query in step S2b gives a positive result, the method is in either case aborted, and is re-started after a determinable time interval has elapsed.

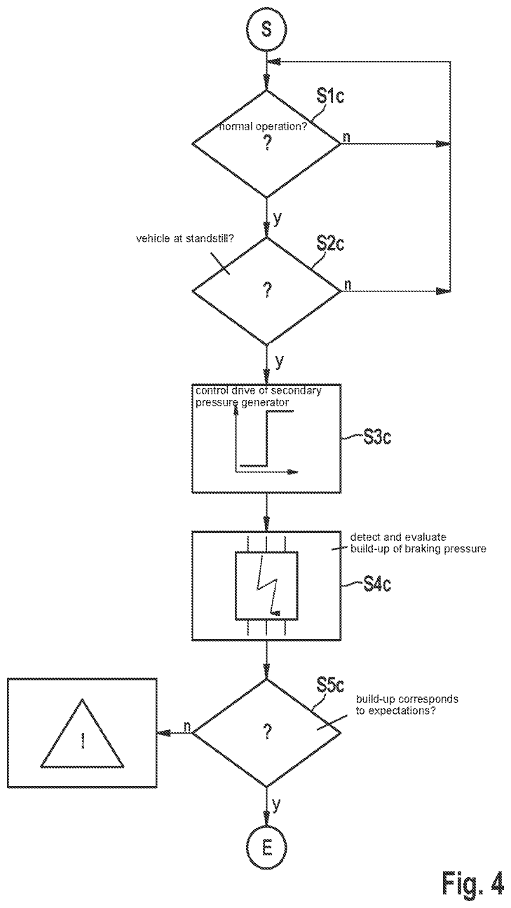

FIG. 4 illustrates a second alternative for a checking method, of which the flow chart corresponds to that of the method according to FIG. 2.

In this second alternative, there is a query in step S1c as to whether the power brake system is in normal operation. If it is, there is a query as to whether the vehicle is at a standstill. (Step 2c). The method only continues if the returned message is positive; otherwise it is aborted and re-started later.

In step S3c, the drive of secondary pressure generator (30) undergoes electrical control by electronic control device (24), as a result of which pressure is built up in power brake system (10), including its connected wheel brakes (16). The build-up of pressure is detected electronically and evaluated in electronic control device (24) in step S4c. Steps S4c and S5c correspond to steps S4, S5 and S4b, S5b as described above.

It goes without saying that modifications or additions to the described methods are possible without departing from the basic concept of the present invention.

In this context, it should be pointed out that, in all the described variants, the build-up of pressure by secondary pressure generator (30) is detected and evaluated directly, in that a pressure measurement is carried out in the hydraulic circuits of power brake system (10) with the aid of the braking pressure adjusting sensor system provided.

However, in principle it is possible that the pressure is detected indirectly. For this purpose, it is possible to take account of the power that is consumed by drive (32) of secondary pressure generator (30) during pressure build-up. This power can be deduced from the electrical current flowing to drive (32), and is in proportion to the generated braking pressure.

The checking method that is described in each case is repeated at intervals. In this context, the time intervals between two checking cycles can be determined however desired, and may vary for example depending on the amount of use made of the power brake system in the intervening period.

1-9. (canceled)

10. A method for checking availability of a hydraulic fallback level in a power brake system with electronic slip control, of a motor vehicle, the power brake system configured to supply connected wheel brakes with pressurized medium under braking pressure and including a plurality of pressure generators, of which respective drives are controllable separately from one another by at least one electronic control device, the power brake system being set up for operation in a normal operation in which a necessary braking event is detected by the electronic control device and associated with a braking pressure which can be set at the wheel brakes by corresponding electrical control of the drive of a primary pressure generator, and at least one electrically controllable secondary pressure generator being provided configured to adapt the braking pressure to a respective wheel slip that currently prevails at wheels associated with the wheel brakes, and the power brake system being set up for operation at a hydraulic fallback level at which the braking pressure can be set at the wheel brakes of the power brake system by a corresponding electronic control of the drive of the secondary pressure generator as a result of a fault occurring in the generation of braking pressure by the primary pressure generator, the method comprising:
during the normal operation of the power brake system, checking availability of the hydraulic fallback level at determinable time intervals.

11. The method as recited in claim 10, wherein the availability of the hydraulic fallback level is checked in that, during the normal operation of the power brake system, when a braking request is made, the electronic control device suppresses a drive of the primary pressure generator and controls the drive of the secondary pressure generator electrically in order to build up braking pressure in the wheel brakes.

12. The method as recited in claim 10, wherein the availability of the hydraulic fallback level is checked in that, during the normal operation of the power brake system, a drive of the secondary pressure generator is controlled electrically in an absence of a braking request when, at the latest on electrical control of the drive of the secondary pressure generator, a hydraulic connection between the secondary pressure generator and the wheel brakes is broken, by electrical control of a valve device.

13. The method as recited in claim 10, wherein the availability of the hydraulic fallback level is checked after the motor vehicle equipped with the power brake system has come to a standstill, a drive of the secondary pressure generator being controlled electrically during the standstill to build up a braking pressure in at least one of the wheel brakes.

14. The method as recited in claim 10, wherein a conclusion is drawn that there is availability of the hydraulic fallback level when the braking pressure generated by the secondary pressure generator is equal to or greater than a specifiable limit value for the braking pressure which is stored in the electronic control device of the power brake system.

15. The method as recited in claim 10, wherein the braking pressure in the power brake system that is generated by the electrically controlled secondary pressure generator is measured and evaluated directly, or the braking pressure that has built up is deduced indirectly based on a characteristic of power consumed by the drive of the secondary pressure generator.

16. The method as recited in claim 15, wherein the power of the secondary pressure generator is detected by measuring current flowing to the drive of the secondary pressure generator.

17. An electronic control device for a power brake system with electronic slip control, of a motor vehicle, the electronic control device configured to check availability of a hydraulic fallback level in the power brake system, the power brake system configured to supply connected wheel brakes with pressurized medium under braking pressure and including a plurality of pressure generators, of which respective drives are controllable separately from one another by the electronic control device, the power brake system being set up for operation in a normal operation in which a necessary braking event is detected by the electronic control device and associated with a braking pressure which can be set at the wheel brakes by corresponding electrical control of the drive of a primary pressure generator, and at least one electrically controllable secondary pressure generator being provided configured to adapt the braking pressure to a respective wheel slip that currently prevails at wheels associated with the wheel brakes, and the power brake system being set up for operation at a hydraulic fallback level at which the braking pressure can be set at the wheel brakes of the power brake system by a corresponding electronic control of the drive of the secondary pressure generator as a result of a fault occurring in the generation of braking pressure by the primary pressure generator, the electronic control device configured to:
during the normal operation of the power brake system, check availability of the hydraulic fallback level at determinable time intervals.

18. A power brake system with electronic slip control, which is equipped with an electronic control device, the electronic control device configured to check availability of a hydraulic fallback in the power brake system, the power brake system configured to supply connected wheel brakes with pressurized medium under braking pressure and including a plurality of pressure generators, of which respective drives are controllable separately from one another by the electronic control device, the power brake system being set up for operation in a normal operation in which a necessary braking event is detected by the electronic control device and associated with a braking pressure which can be set at the wheel brakes by corresponding electrical control of the drive of a primary pressure generator, and at least one electrically controllable secondary pressure generator being provided configured to adapt the braking pressure to a respective wheel slip that currently prevails at wheels associated with the wheel brakes, and the power brake system being set up for operation at a hydraulic fallback level at which the braking pressure can be set at the wheel brakes of the power brake system by a corresponding electronic control of the drive of the secondary pressure generator as a result of a fault occurring in the generation of braking pressure by the primary pressure generator, the electronic control device configured to:
during the normal operation of the power brake system, check availability of the hydraulic fallback level at determinable time intervals.
